(19) United States
(12) Patent Application Publication
(10) Pub. No.: US 2025/0122437 A1
(43) Pub. Date: Apr. 17, 2025

(54) System and Method for Removing Hydrogen Sulfide From Sour Natural Gas

(71) Applicant: Pinedale Holdings LLC, Little Rock, AR (US)

(72) Inventor: James Huddleston, Millsap, TX (US)

(21) Appl. No.: 18/915,688

(22) Filed: Oct. 15, 2024

Related U.S. Application Data
(60) Provisional application No. 63/589,716, filed on Oct. 12, 2023.

(51) Int. Cl. C10L 3/10; B01D 21/26; B01D 53/14; B01D 53/18; B04B 1/20; C01B 17/04

(52) U.S. Cl. CPC C10L 3/103; B01D 21/262; B01D 53/1418; B01D 53/1425; B01D 53/1431; B01D 53/1468; B01D 53/1493; B01D 53/18; B04B 1/20; C01B 17/0447; B01D 2252/2026; B01D 2257/304; C10L 2290/545

(57) ABSTRACT

A method for processing includes reacting hydrogen sulfide (H₂S), in a sour NG stream, and a sulfur dioxide (SO₂) stream, the sour NG stream having a molar concentration of at least about 0.5% H₂S, the reactor output including sulfur, water, and a reacted NG stream having a lower molar concentration of H₂S compared to the sour NG stream; contacting the reactor output and a liquid solvent in a solvent wash column to remove at least some H₂S from the reacted NG stream to produce a treated NG stream, the treated NG stream having a lower molar concentration of H₂S compared to the reacted NG stream, the solvent wash column further outputting a solvent mixture stream that includes at least the liquid solvent and the sulfur; and separating, with a centrifuge, the solvent mixture stream into solid sulfur and a recyclable liquid solvent stream.

### CROSS-REFERENCE TO RELATED APPLICATIONS

This application claims priority to U.S. Provisional Application No. 63/589,716, titled “System and Method for Removal of Sulfur Products from Natural Gas Process,” filed on Oct. 12, 2023, which is hereby incorporated by reference.

### TECHNICAL FIELD

This application relates generally to natural gas processing.

### BACKGROUND

Hydrogen sulfide (H₂S) is corrosive and toxic and the removal of H₂S is required for pipeline gas transportation and end-use of natural gas. Prior methods, e.g., F. M. Townsend (U.S. Pat. No. 2,881,047) have attempted to address this problem but remain lacking in part due to the difficulty in processing resulting sulfur products, and are especially ineffective for smaller volume operations, especially having higher H₂S stream concentrations.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a system for processing sour natural gas, comprising a sour natural gas source outputting a sour natural gas stream, the sour natural gas stream having a molar concentration of at least about 0.5% hydrogen sulfide (H₂S); a sulfur dioxide (SO₂) source outputting an SO₂ stream; a mixer having inputs fluidly coupled to the sour natural gas source and the SO₂ source, the mixer configured to mix the sour natural gas stream and the SO₂ stream to produce a mixed gas stream; a reactor having an input that receives the mixed gas stream and reacts the H₂S and SO₂ to form sulfur and water, the reactor outputting a reacted natural gas stream, the sulfur, and the water, the reacted natural gas stream having a lower molar concentration of the H₂S compared to the sour natural gas stream; a solvent source outputting a liquid solvent stream; a solvent wash column having a first input that receives the reacted natural gas stream and a second input that receives at least the liquid solvent stream, the first input at or near a bottom of the solvent wash column, the second input at or near a top of the solvent wash column, the liquid solvent stream removing at least some of the H₂S from the reacted natural gas stream to produce a treated natural gas stream at a first output of the solvent wash column, the treated natural gas stream having a lower molar concentration of the H₂S compared to the reacted natural gas stream; and a centrifuge having an input fluidly coupled to a second output of the solvent wash column to receive a solvent mixture stream that includes at least liquid solvent and sulfur, the centrifuge separating the sulfur and the liquid solvent and producing the sulfur and the liquid solvent at first and second outputs, respectively.

In one or more embodiments, the system further comprises a solvent recycling system fluidly coupled to the second output of the centrifuge. In one or more embodiments, the mixer is configured to adjust a flow rate of the sour natural gas stream and a flow rate of the SO₂ stream such that the mixed gas stream has a ratio of about 3 mols H₂S per mol of SO₂.

In one or more embodiments, the centrifuge comprises a decanter centrifuge. In one or more embodiments, the liquid solvent comprises a glycol. In one or more embodiments, the glycol comprises triethylene glycol. In one or more embodiments, a sulfur cake is produced at the first output of the centrifuge.

Another aspect of the invention is directed to a method for processing sour natural gas, comprising reacting, in a reactor, hydrogen sulfide (H₂S) in a stream of sour natural gas and a stream of sulfur dioxide (SO₂) to form sulfur and water, the sour natural gas stream having a molar concentration of at least about 0.5% of the H₂S, the reactor having an output that includes the sulfur, the water, and a reacted natural gas stream that has a lower molar concentration of the H₂S compared to the stream of sour natural gas; contacting the output of the reactor and a liquid solvent in a solvent wash column, the liquid solvent removing at least some of the H₂S from the reacted natural gas stream to produce a treated natural gas stream at a first output of the solvent wash column, the treated natural gas stream having a lower molar concentration of the H₂S compared to the reacted natural gas stream, the solvent wash column including a second output that produces a solvent mixture stream that includes at least the liquid solvent and the sulfur; and separating, with a centrifuge, the solvent mixture stream into a solid sulfur and a recyclable liquid solvent stream.

In one or more embodiments, the method further comprises removing one or more impurities from the recyclable liquid solvent stream using a solvent stripper to form a purified recyclable liquid solvent stream. In one or more embodiments, the method further comprises flowing the purified recyclable liquid solvent stream into the solvent wash column.

In one or more embodiments, the method further comprises adjusting a flow rate of the stream of sour natural gas and a flow rate of the SO₂ to produce a mixed gas stream having a ratio of about 3 mols H₂S per mol of SO₂; and introducing the mixed gas stream into the reactor.

In one or more embodiments, the centrifuge comprises a decanter centrifuge. In one or more embodiments, the liquid solvent comprises a glycol. In one or more embodiments, the glycol comprises triethylene glycol. In one or more embodiments, the solid sulfur comprises a sulfur cake.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a block diagram of a system for processing sour natural gas according to one or more embodiments.

FIG. 2 is a flow chart of a method for processing sour natural gas according to one or more embodiments.

### DETAILED DESCRIPTION

Hydrogen sulfide (H₂S), in a sour natural gas (NG) stream, and a sulfur dioxide (SO₂) stream are combined and reacted, in a reactor to form sulfur and water. The sour NG stream has a molar concentration of at least about 0.5% H₂S. The reactor output includes a reacted NG stream having a lower molar concentration of H₂S compared to the sour NG stream. The reactor output also includes sulfur and water. The reactor output and a liquid solvent are contacted in a solvent wash column to remove at least some H₂S from the reacted NG stream to produce, at a top output of the solvent wash column, a treated NG stream. The treated NG stream has a lower molar concentration of H₂S compared to the reacted NG stream. A bottom output of the solvent wash column produces a solvent mixture stream that includes at least the liquid solvent and sulfur. The liquid solvent and sulfur are separated using a centrifuge into solid sulfur (e.g., sulfur cake) and a recyclable liquid solvent stream. The recyclable liquid solvent stream can be purified (e.g., using a solvent stripper) and recycled back to the solvent wash column.

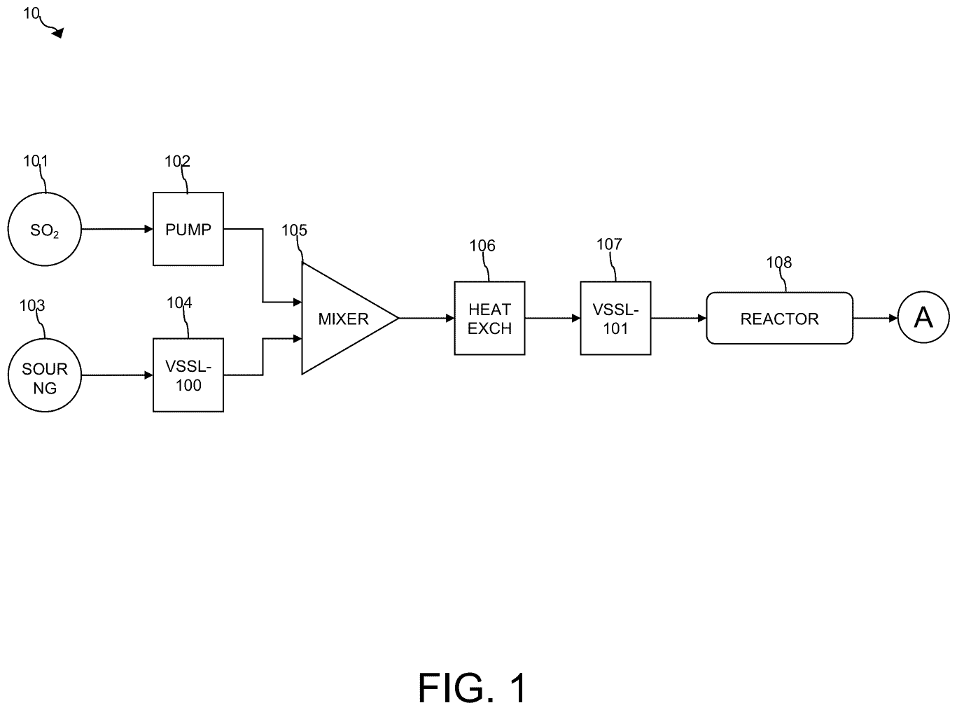

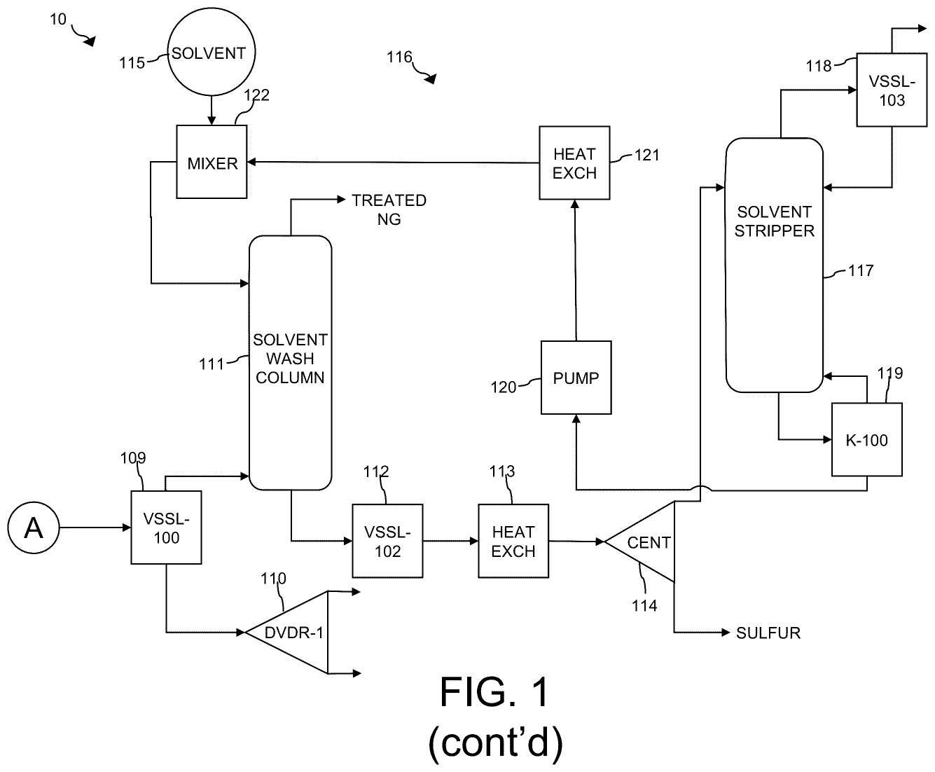

FIG. 1 is a block diagram of a system 10 for processing sour natural gas (NG) according to one or more embodiments. The system 10 includes a sulfur dioxide (SO₂) source 101, an optional pump 102, a sour NG source 103, an optional vessel 104, a mixer 105, an optional heat exchanger 106, an optional vessel 107, a reactor 108, an optional vessel 109, an optional divider 110, a solvent wash column 111, an optional vessel 112, an optional heat exchanger 113, a centrifuge 114, a solvent source 115, and an optional solvent recycle system 116.

The mixer 105 is fluidly coupled to the SO₂ source 101 and the sour NG gas source 103 to receive and mix respective streams of SO₂ and sour NG to produce a gas mixture. The sour NG includes hydrogen sulfide (H₂S) at a high concentration such as about 0.5 molar percent to about 5 molar percent including about 1 molar percent, about 2 molar percent, about 3 molar percent, about 4 molar percent, and any value or range between any two of the foregoing values. As used herein, “about” means plus or minus 10% of the relevant value. The relative flow rates of the SO₂ and sour NG streams can be adjusted such that the mixer 105 produces a mixture having a ratio of about 3 mols H₂S per mol of SO₂ (e.g., a 3:1 molar ratio of H₂S and SO₂, respectively). In one or more embodiments, the mixer 105 produces a mixture having a molar ratio of about 2:1 to about 5:1 of H₂S and SO₂, respectively, including any value or range therebetween.

The pump 102 can pressurize and/or regulate flow of the SO₂ stream. The SO₂ in the SO₂ stream can be in liquid or gas form. In one or more embodiments, the SO₂ source 101 can be pressurized and a valve, instead of or in addition to the pump 102, can be used to regulate flow of the SO₂ stream.

The output of the mixer 105 is fluidly coupled to the input of the optional heat exchanger 106 and/or to the input of the optional vessel 107.

The reactor 108 is configured to cause a reaction between SO₂ and H₂S in the sour natural gas to substantially reduce the concentration of H₂S in the sour natural gas. The SO₂ and H₂S can react according to the Claus reaction:

2H₂S+SO₂→S+2H₂O

The reactor 108 can operate at about 200 psig to about 250 psig, including any value or range therebetween, and at a temperature of about 80° F. to about 120° F., including any value or range therebetween. The SO₂ and H₂S can come into contact over conventional packing media in the reactor 108. The output of the reactor 108 is or includes a slurry of sulfur (e.g., crystals, particles, and/or other form(s) of sulfur), purified natural gas, and any unreacted SO₂. The purified natural gas has an H₂S concentration that is lower than the H₂S concentration of the sour natural gas. In a simulation, the purified natural gas had an H₂S concentration of 7.8454 ppm (parts per million) and the sour natural gas had a molar concentration of 4% H₂S and a molar flow rate of 4.3919 lbmol/hour H₂S.

The Claus reaction is exothermic resulting in temperature increases in the purified gas at the output of the reactor 108 compared to the temperature of the gas mixture at the input of the reactor 108. The reactor 108 can be air cooled to remove some or all of the heat of reaction.

The output of the reactor 108 is fluidly coupled to (via placeholder A) an optional vessel 109 and/or to an input of the solvent wash column 111. The purified natural gas can be introduced at or near a bottom input of the solvent wash column 111 and can flow upwards through the solvent wash column 111. A liquid solvent flows downward through an top input of the solvent wash column 111 such that liquid solvent and the purified natural gas contact each other throughout some or all of the height of the solvent wash column 111. The solvent can reduce the concentration of H₂S in the purified natural gas stream, for example by aiding in the conversion of H₂S to sulfur. In addition, the solvent can absorb unreacted SO₂ and can remove water (e.g., dehydrate) that may be flowing in the purified natural gas stream. In some embodiments, the absorbed SO₂ can be recovered from the solvent in a recycling process.

The solvent can include or consist of a glycol (e.g., a glycol derivate) such as triethylene glycol (TEG). Additional and/or alternative solvent(s) can be used in other embodiments. The solvent can be provided from the solvent source 115 which is fluidly coupled to (e.g., a top input of) the solvent wash column 111.

A treated natural gas stream is output at a top output of the solvent wash column 111. The treated natural gas in the treated natural gas stream has an H₂S concentration that is lower than the H₂S concentration of the purified natural gas output from the reactor 108 and lower than the H₂S concentration of the sour natural gas (e.g., from the sour natural gas source 103). In a simulation, the treated natural gas had a molar concentration of 0.00074367%, the purified natural gas had an H₂S concentration of 7.8454 ppm, and the sour natural gas had a molar concentration of 4% H₂S with a molar flow rate of 4.3919 lbmol/hour H₂S. Thus, the molar concentration of H₂S was reduced by a factor of over 5,000 in the treated natural gas compared to the sour natural gas.

A solvent mixture stream is output at the bottom output of the solvent wash column 111. The solvent mixture stream is input to an optional vessel 112 and/or to an optional heat exchanger 113. The solvent mixture stream includes at least the liquid solvent that has passed through the solvent wash column 111 and sulfur (e.g., in solid or crystalline form). The solvent mixture stream can also include water and/or any chemicals (e.g., H₂S) absorbed from the treated natural gas stream.

The output of the solvent wash column 111, of the optional vessel 112, and/or of the optional heat exchanger 113 is fluidly coupled to the input of the centrifuge 114. The centrifuge 114 separates the solvent mixture stream into solid sulfur (e.g., sulfur cake) at a first output of the centrifuge 114 and recyclable solvent at a second output of the centrifuge 114. The solid sulfur is generally non-hazardous to transport. At lower volumes, the solid sulfur may be disposed of at a landfil. There may be regional interest for fertilization use of the solid sulfur as well. In some embodiments, the centrifuge 114 can be or comprise a decanter centrifuge.

The second output of the centrifuge 114 can be fluidly coupled to the input of the solvent recycle system 116. Alternatively, the recyclable solvent can be discarded (e.g., when the system 10 does not include a solvent recycle system 116).

The optional solvent recycle system 116 includes a solvent stripper 117, an optional vessel 118, an optional K-100 119, an optional pump 120, an optional heat exchanger 121, and a mixer 122.

When the system 10 includes a solvent recycle system 116, the second output of the centrifuge 114 is fluidly coupled to the input of the solvent stripper 117 to receive the recyclable solvent stream. The solvent stripper 117 is configured to remove one or more impurities from the recyclable solvent stream. A purified recyclable solvent stream is output from the K-100 119. Impurities can be output from the vessel 118, which is fluidly coupled to the top of the solvent stripper 117.

The purified recyclable solvent stream is combined with a solvent stream (e.g., a virgin solvent stream) from the solvent source 115 in the mixer 122. The purified recyclable solvent stream can optionally be pumped by the pump 120 and/or cooled/heated by the heat exchanger 121.

Example physical and chemical properties of the sour natural gas stream and the treated natural gas streams from the simulation are provided in Table 1.

TABLE 1

| | | Sour | Treated Natural |
|---|---|---|---|
| Name | Units | Natural Gas | Gas |
| Pressure | psig | 120 | 119.5 |
| Temperature | ° F. | 200 | 130.87 |
| Std Vapor Volumetric | MMSCFD | 1 | 0.96305 |
| Flow | | | |
| H₂S (mole fraction) | % | 4 | 0.00074367 |
| N₂ (mole fraction) | % | 1 | 1.0372 |
| CO₂ (mole fraction) | % | 2 | 2.036 |
| C1 (mole fraction) | % | 78.52 | 81.391 |
| C2 (mole fraction) | % | 8 | 8.2919 |
| C3 (mole fraction) | % | 5 | 5.1823 |
| iC4 (mole fraction) | % | 0.32 | 0.33181 |
| nC4 (mole fraction) | % | 0.6 | 0.62159 |
| iC5 (mole fraction) | % | 0.1 | 0.10318 |
| nC5 (mole fraction) | % | 0.4 | 0.41419 |
| C6 (mole fraction) | % | 0.05 | 0.051713 |
| C7 (mole fraction) | % | 0.01 | 0.010318 |
| H₂O (mole fraction) | % | 0 | 0.016241 |
| S1 (mole fraction) | % | 0 | 0 |
| S2 (mole fraction) | % | 0 | 0 |
| S3 (mole fraction) | % | 0 | 0 |
| S4 (mole fraction) | % | 0 | 0 |
| S5 (mole fraction) | % | 0 | 0 |
| S6 (mole fraction) | % | 0 | 1.0751e−05 |
| S7 (mole fraction) | % | 0 | 1.1681e−05 |
| S8 (mole fraction) | % | 0 | 0.0008583 |
| SO2 (mole fraction) | % | 0 | 0.49469 |
| Ethylene Glycol | % | 0 | 0.016021 |
| (mole fraction) | | | |

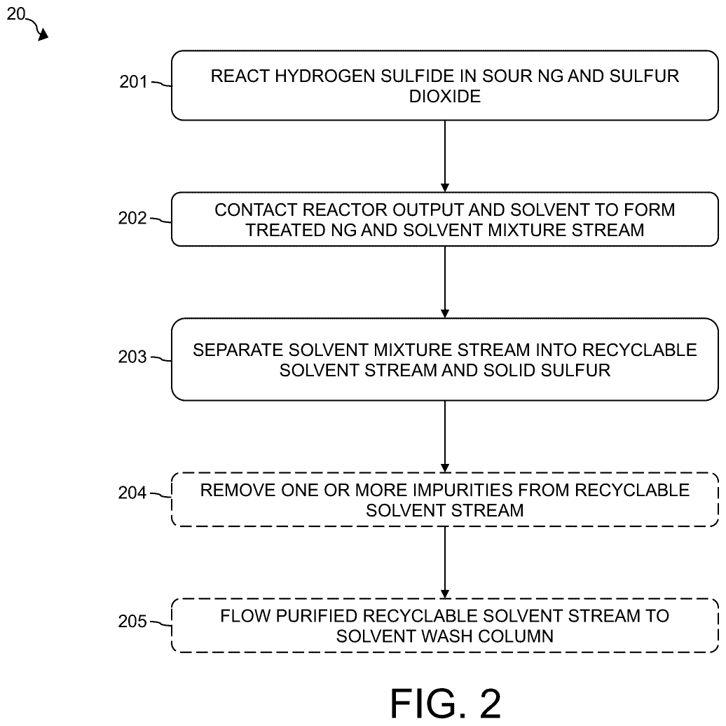

FIG. 2 is a flow chart of a method 20 for processing sour NG according to one or more embodiments. The method 20 can be performed using system 10.

In step 201, H₂S in sour NG and SO₂ are reacted in a reactor 108 to form sulfur and water (e.g., according to the Claus reaction). The flow rates of the sour NG and the SO₂ can be controlled such that there is molar ratio of about 2:1 to about 5:1 of H₂S and SO₂ where the H₂S is present in the sour NG. The sour NG and the SO₂ can be mixed before entering the reactor 108. The output of the reactor 108 is or includes a slurry of sulfur (e.g., crystals, particles, and/or other form(s) of sulfur), purified natural gas, and any unreacted SO₂. The purified natural gas has an H₂S concentration that is lower than the H₂S concentration of the sour natural gas.

In step 202, the reactor output is fed into the bottom input of a solvent wash column 111 where the reactor output and a solvent contact one another. The solvent can reduce the concentration of H₂S in the purified natural gas stream, for example by aiding in the conversion of H₂S to sulfur. In addition, the solvent can absorb unreacted SO₂ and can remove water (e.g., dehydrate) that may be flowing in the purified natural gas stream. In some embodiments, the absorbed SO₂ can be recovered from the solvent in a recycling process. The solvent can include or consist of a glycol (e.g., a glycol derivate) such as TEG. The solvent can be fed into the top input of the solvent wash column 111. The solvent can be provided by a solvent source 115 and optionally by a solvent recycle system 116.

The solvent wash column 111 produces a treated natural gas stream at the top output of the solvent wash column 111 and a solvent mixture stream at the bottom output of the solvent wash column 111. The treated natural gas in the treated natural gas stream has an H₂S concentration that is lower than the H₂S concentration of the purified natural gas output from the reactor 108 and lower than the H₂S concentration of the sour natural gas (e.g., from the sour natural gas source 103). The solvent mixture stream includes at least the liquid solvent that has passed through the solvent wash column 111 and sulfur (e.g., in solid or crystalline form). The solvent mixture stream can also include water and/or any chemicals absorbed from the treated natural gas stream.

In step 203, the solvent mixture stream is fed into a centrifuge 114 to separate the solvent mixture stream into a recyclable solvent stream and solid sulfur. The centrifuge 114 can be or can comprise a decanter centrifuge.

In optional step 204, one or more impurities is/are removed from the recyclable solvent stream. The impurity (ies) can be removed using a solvent stripper 117.

In optional step 205, a purified recyclable solvent stream is fed into the top input of the solvent wash column 111. Additional (e.g., virgin) solvent can be combined with the purified recyclable solvent stream.

The invention should not be considered limited to the particular embodiments described above, but rather should be understood to cover all aspects of the invention as fairly set out in the attached claims. Various modifications, equivalent processes, as well as numerous structures to which the invention may be applicable, will be apparent to those skilled in the art to which the invention is directed upon review of this disclosure. The claims are intended to cover such modifications and equivalents.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A system for processing sour natural gas, comprising:
a sour natural gas source outputting a sour natural gas stream, the sour natural gas stream having a molar concentration of at least about 0.5% hydrogen sulfide (H₂S);
a sulfur dioxide (SO₂) source outputting an SO₂ stream;
a mixer having inputs fluidly coupled to the sour natural gas source and the SO₂ source, the mixer configured to mix the sour natural gas stream and the SO₂ stream to produce a mixed gas stream;
a reactor having an input that receives the mixed gas stream and reacts the H₂S and SO₂ to form sulfur and water, the reactor outputting a reacted natural gas stream, the sulfur, and the water, the reacted natural gas stream having a lower molar concentration of the H₂S compared to the sour natural gas stream;
a solvent source outputting a liquid solvent stream;
a solvent wash column having a first input that receives the reacted natural gas stream and a second input that receives at least the liquid solvent stream, the first input at or near a bottom of the solvent wash column, the second input at or near a top of the solvent wash column, the liquid solvent stream removing at least some of the H₂S from the reacted natural gas stream to produce a treated natural gas stream at a first output of the solvent wash column, the treated natural gas stream having a lower molar concentration of the H₂S compared to the reacted natural gas stream; and
a centrifuge having an input fluidly coupled to a second output of the solvent wash column to receive a solvent mixture stream that includes at least liquid solvent and sulfur, the centrifuge separating the sulfur and the liquid solvent and producing the sulfur and the liquid solvent at first and second outputs, respectively.

2. The system of claim 1, further comprising a solvent recycling system fluidly coupled to the second output of the centrifuge.

3. The system of claim 1, wherein the mixer is configured to adjust a flow rate of the sour natural gas stream and a flow rate of the SO₂ stream such that the mixed gas stream has a ratio of about 3 mols H₂S per mol of SO₂.

4. The system of claim 1, wherein the centrifuge comprises a decanter centrifuge.

5. The system of claim 1, wherein the liquid solvent comprises a glycol.

6. The system of claim 5, wherein the glycol comprises triethylene glycol.

7. The system of claim 1, wherein a sulfur cake is produced at the first output of the centrifuge.

8. A method for processing sour natural gas, comprising:
reacting, in a reactor, hydrogen sulfide (H₂S) in a stream of sour natural gas and a stream of sulfur dioxide (SO₂) to form sulfur and water, the sour natural gas stream having a molar concentration of at least about 0.5% of the H₂S, the reactor having an output that includes the sulfur, the water, and a reacted natural gas stream that has a lower molar concentration of the H₂S compared to the stream of sour natural gas;
contacting the output of the reactor and a liquid solvent in a solvent wash column, the liquid solvent removing at least some of the H₂S from the reacted natural gas stream to produce a treated natural gas stream at a first output of the solvent wash column, the treated natural gas stream having a lower molar concentration of the H₂S compared to the reacted natural gas stream, the solvent wash column including a second output that produces a solvent mixture stream that includes at least the liquid solvent and the sulfur; and
separating, with a centrifuge, the solvent mixture stream into a solid sulfur and a recyclable liquid solvent stream.

9. The method of claim 8, further comprising removing one or more impurities from the recyclable liquid solvent stream using a solvent stripper to form a purified recyclable liquid solvent stream.

10. The method of claim 9, further comprising flowing the purified recyclable liquid solvent stream into the solvent wash column.

11. The method of claim 8, further comprising:
adjusting a flow rate of the stream of sour natural gas and a flow rate of the SO₂ to produce a mixed gas stream having a ratio of about 3 mols H₂S per mol of SO₂; and
introducing the mixed gas stream into the reactor.

12. The system of claim 8, wherein the centrifuge comprises a decanter centrifuge.

13. The system of claim 8, wherein the liquid solvent comprises a glycol.

14. The system of claim 13, wherein the glycol comprises triethylene glycol.

15. The system of claim 8, wherein the solid sulfur comprises a sulfur cake.
